(19) United States
(12) Patent Application Publication
(10) Pub. No.: US 2021/0197723 A1
(43) Pub. Date: Jul. 1, 2021

(54) INFORMATION PROCESSING APPARATUS, INFORMATION PROCESSING SYSTEM, INFORMATION PROCESSING METHOD, AND PROGRAM

(71) Applicant: SONY SEMICONDUCTOR SOLUTIONS CORPORATION, KANAGAWA (JP)

(72) Inventor: SHINJI TAKAHASHI, KANAGAWA (JP)

(21) Appl. No.: 17/250,709

(22) PCT Filed: Aug. 16, 2019
(86) PCT No.: PCT/JP2019/032119

§ 371 Date: Feb. 22, 2021

(30) Foreign Application Priority Data
Sep. 4, 2018 (JP) 2018-164999

(51) Int. Cl. B60R 1/00; G06K 9/00

(52) U.S. Cl. CPC B60R 1/002; G06K 9/00812; B60R 2300/302; B60R 2300/105; B60R 2300/806

(57) ABSTRACT

A configuration is implemented in which a user who is away from a vehicle can easily check a vehicle parking position. Included is an image processing unit that inputs an image captured by a camera, and generates transmission data to be transmitted to an external device, the camera being configured to capture an image of surroundings of a vehicle. The image processing unit generates transmission data by using a moving image captured at the time of parking the vehicle and stored in a storage unit, and transmits the generated transmission data to an external device such as a user terminal via a communication unit. The image processing unit generates a surround-view image on the basis of images captured by a plurality of cameras provided on the front, back, left, and right of the vehicle, and transmits the generated surround-view image. In addition, the image processing unit detects identification information including a character, a numeral, or a symbol from the image captured by the camera, and transmits an image including the detected identification information.

### TECHNICAL FIELD

The present disclosure relates to an information processing apparatus, an information processing system, an information processing method, and a program. Specifically, the present disclosure relates to an information processing apparatus, an information processing system, an information processing method, and a program that enable a user who is away from a vehicle to be notified of a parking position of the vehicle in an easy-to-understand manner.

### BACKGROUND ART

Many of suburban shopping centers, amusement parks, tourist spots, and the like have large parking lots. It often happens that a driver forgets a parking position as time passes after parking a vehicle in such a large parking lot and leaving the vehicle.

Meanwhile, many of recent models of vehicles are each equipped with a camera that captures an image of surroundings of the vehicle. For example, this camera is mainly used for displaying, on a driver's seat monitor, images of a rear view, a left-side view, and a right-side view from the vehicle when the vehicle is backed or parked, so as to enable safe driving.

For example, there is an image presentation system that generates a virtual image of a vehicle viewed from above on the basis of images captured by a plurality of wide-angle cameras mounted on the front, back, and sides of the vehicle, and displays the virtual image on a driver's seat display unit. The virtual observation image of the vehicle viewed from above is referred to as a “surround-view image”, an “overhead view image”, a “bird's-eye view image”, or the like.

Note that, for example, Patent Document 1 (Japanese Patent Application Laid-Open No. 2018-45482) can be cited as a related art document that discloses a configuration in which a virtual observation image of a vehicle viewed from above is generated and displayed on a driver's seat monitor. However, in order to display the image on the driver's seat monitor and check the image, it is necessary for a driver to get in the vehicle and turn on the power of the vehicle. That is, after the vehicle is parked and the power of the vehicle is turned off, the camera also stops a process of capturing images. Furthermore, in a case where the driver leaves the vehicle, it is not possible to view images captured by the camera.

### CITATION LIST

### Patent Document

Patent Document 1: Japanese Patent Application Laid-Open No. 2018-45482

### SUMMARY OF THE INVENTION

### Problems to be Solved by the Invention

An object of the present disclosure is to provide an information processing apparatus, an information processing system, an information processing method, and a program that enable a user who is away from a vehicle to be notified of a parking position of the vehicle in an easy-to-understand manner.

Furthermore, in one embodiment of the present disclosure, an object of the present disclosure is to provide an information processing apparatus, an information processing system, an information processing method, and a program that enable a user who is away from a vehicle to be notified of a parking position of the vehicle in an easy-to-understand manner, by transmitting an image of surroundings of the vehicle captured by a camera provided in the vehicle to a mobile terminal such as a smartphone held by the user.

### Solutions to Problems

A first aspect of the present disclosure is an information processing apparatus including:

an image processing unit that inputs an image captured by a camera, and generates transmission data to be transmitted to an external device, the camera being configured to capture an image of surroundings of a vehicle,

in which the image processing unit stores a moving image captured at a time of parking the vehicle in a storage unit, generates transmission data by using the moving image captured at the time of parking the vehicle and stored in the storage unit, and transmits the generated transmission data to the external device via a communication unit.

In addition, a second aspect of the present disclosure is an information processing system including:

an information processing apparatus installed in a vehicle; and

a user terminal capable of communicating with the information processing apparatus,

in which the information processing apparatus includes an image processing unit that inputs an image captured by a camera, and generates transmission data to be transmitted to the user terminal, the camera being configured to capture an image of surroundings of the vehicle,

the image processing unit stores a moving image captured at a time of parking the vehicle in a storage unit, generates transmission data by using the moving image captured at the time of parking the vehicle and stored in the storage unit, and transmits the generated transmission data to the user terminal via a communication unit, and

the user terminal displays the data received from the information processing apparatus, on a display unit.

Moreover, a third aspect of the present disclosure is an information processing method to be performed in an information processing apparatus including an image processing unit that inputs an image captured by a camera, and generates transmission data to be transmitted to an external device, the camera being configured to capture an image of surroundings of a vehicle, the method including:

causing the image processing unit to store a moving image captured at a time of parking the vehicle in a storage unit, generate transmission data by using the moving image captured at the time of parking the vehicle and stored in the storage unit, and transmit the generated transmission data to the external device via a communication unit.

Furthermore, a fourth aspect of the present disclosure is an information processing method to be performed in an information processing system, the information processing system including an information processing apparatus installed in a vehicle, and a user terminal capable of communicating with the information processing apparatus, the information processing apparatus including an image processing unit that inputs an image captured by a camera, and generates transmission data to be transmitted to the user terminal, the camera being configured to capture an image of surroundings of the vehicle, the method including:

causing the image processing unit to store a moving image captured at a time of parking the vehicle in a storage unit, generate transmission data by using the moving image captured at the time of parking the vehicle and stored in the storage unit, and transmit the generated transmission data to the user terminal via a communication unit, and

causing the user terminal to display the data received from the information processing apparatus, on a display unit.

In addition, a fifth aspect of the present disclosure is a program for causing a vehicle management process to be performed in an information processing apparatus including an image processing unit that inputs an image captured by a camera, and generates transmission data to be transmitted to an external device, the camera being configured to capture an image of surroundings of a vehicle, the program causing the image processing unit to perform:

a process of storing a moving image captured at a time of parking the vehicle in a storage unit;

a process of generating transmission data by using the moving image captured at the time of parking the vehicle and stored in the storage unit; and

a process of transmitting the generated transmission data to the external device via a communication unit.

Note that the program according to the present disclosure is, for example, a program that can be provided through a storage medium or a communication medium to be provided in a computer-readable form to an information processing apparatus, an image processing apparatus, or a computer system that can execute various program codes. As a result of providing such a program in a computer-readable form, a process corresponding to the program is implemented on the information processing apparatus or the computer system.

Still other objects, features, and advantages of the present disclosure will be apparent from more detailed descriptions based on an embodiment of the present invention to be described later and the accompanying drawings. Note that in the present specification, the term “system” refers to a logical set configuration of a plurality of devices, and is not limited to one in which the devices of each configuration are in the same casing.

### Effects of the Invention

According to a configuration of one embodiment of the present disclosure, a configuration is implemented in which a user who is away from a vehicle can easily check a vehicle parking position.

Specifically, for example, included is an image processing unit that inputs an image captured by a camera, and generates transmission data to be transmitted to an external device, the camera being configured to capture an image of surroundings of the vehicle. The image processing unit generates transmission data by using a moving image captured at the time of parking the vehicle and stored in a storage unit, and transmits the generated transmission data to an external device such as a user terminal via a communication unit. The image processing unit generates a surround-view image on the basis of images captured by a plurality of cameras provided on the front, back, left, and right of the vehicle, and transmits the generated surround-view image. In addition, the image processing unit detects identification information including a character, a numeral, or a symbol from the image captured by the camera, and transmits an image including the detected identification information.

With the present configuration, a configuration is implemented in which a user who is away from a vehicle can easily check a vehicle parking position.

Note that the effects described in the present specification are merely illustrative and not restrictive, and additional effects may also be achieved.

### BRIEF DESCRIPTION OF DRAWINGS

FIG. 1 is a diagram describing an outline of a surround-view camera system.

FIG. 2 is a diagram describing a configuration of a vehicle management system according to the present disclosure.

FIG. 3 is a diagram describing a configuration example of the vehicle management system according to the present disclosure.

FIG. 4 is a diagram showing a flowchart describing a process sequence of a process of data transmission from the vehicle management system to be performed as a push-type process.

FIG. 5 is a diagram describing an example of display data of a user terminal.

FIG. 6 is a diagram describing another example of display data of the user terminal.

FIG. 7 is a diagram showing a flowchart describing a process sequence of a process of data transmission from the vehicle management system to be performed as a fetch-type process.

FIG. 8 is a diagram describing still another example of display data of the user terminal.

FIG. 9 is a diagram describing a hardware configuration example of the vehicle management system, the user terminal, and a server.

### MODE FOR CARRYING OUT THE INVENTION

Details of an information processing apparatus, an information processing system, an information processing method, and a program according to the present disclosure will be described below with reference to the drawings. Note that description will be provided in accordance with the following items.

1. Regarding Outline of Surround-View Camera system

2. Regarding Configuration That Enables Checking of Parking Position by Using Image Captured by Camera

3. Regarding Specific Examples of Process of Data Transmission from Vehicle Management System

3-1. Regarding Process of Data Transmission from Vehicle Management System to Be Performed as Push-type Process

3-2. Regarding Process of Data Transmission from Vehicle Management System to Be Performed as Fetch-type Process

4. Regarding Hardware Configuration Example of Vehicle Management System, User Terminal, and Server

5. Summary of Configuration of Present Disclosure

### 1. Regarding Outline of Surround-View Camera System

First, an outline of a surround-view camera system provided in recent models of vehicles will be described.

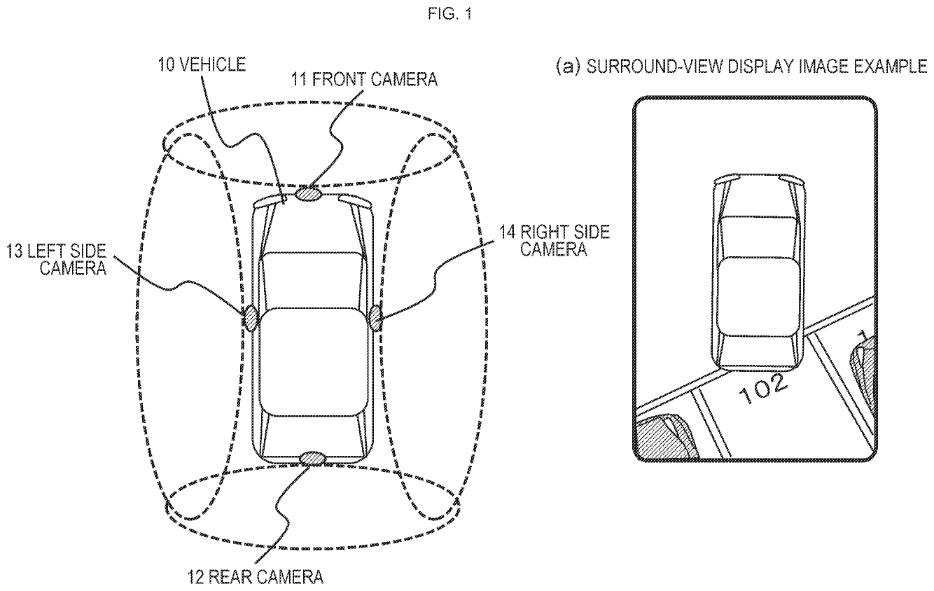

FIG. 1 is a diagram describing an outline of a surround-view camera system. A diagram on the left of FIG. 1 shows a vehicle 10 equipped with the surround-view camera system. The vehicle 10 is equipped with cameras located in four places, that is, the front, back, left, and right of the vehicle 10. That is, a front camera 11, a rear camera 12, a left side camera 13, and a right side camera 14 shown in the drawing are provided in the vehicle 10.

Each of these cameras includes a wide-angle lens such as a fisheye lens, and can capture an image with a wider angle of view. For example, the image capturing area of each camera is shown as a dotted line area in the drawing. It is possible to generate an image of the vehicle observed from above by performing image processing on images captured by these four cameras.

An image shown on the right of FIG. 1 is an example of a display image generated as a result of image processing. This display image is displayed on a driver's seat display unit. Note that a vehicle at the center of this display image is based on virtual data, and is not obtained from the images captured by the cameras.

An image of surroundings of the vehicle is an image generated by image processing based on the images captured by the four cameras, and is pasted with an image of the own vehicle such that the image of the own vehicle is positioned in the center. As a result, an image is generated as if the vehicle was observed from above.

This virtual observation image of the vehicle viewed from above is referred to as a “surround-view image”, an “overhead view image”, a “bird's-eye view image”, or the like.

A driver (a person who drives the vehicle) can check this image through a driver's seat monitor (display unit). This enables the driver to implement vehicle handling such as the backing or parking of the vehicle for safe driving while checking obstacles or the like around the vehicle.

However, in order to display the image on the driver's seat monitor and check the image, it is necessary for a driver to get in the vehicle and turn on the power of the vehicle. That is, after the vehicle is parked and the power of the vehicle is turned off, the camera also stops a process of capturing images.

### 2. Regarding Configuration that Enables Checking of Parking Position by Using Image Captured by Camera

Next, a description will be given of a configuration and processing of a vehicle management apparatus and a vehicle management system corresponding to the information processing apparatus and the information processing system according to the present disclosure, respectively. According to the configuration and processing of the present disclosure, even in a case where a driver (user) parks a vehicle and then leaves the vehicle, the driver can check the parking position by using an image captured by the camera provided in the vehicle.

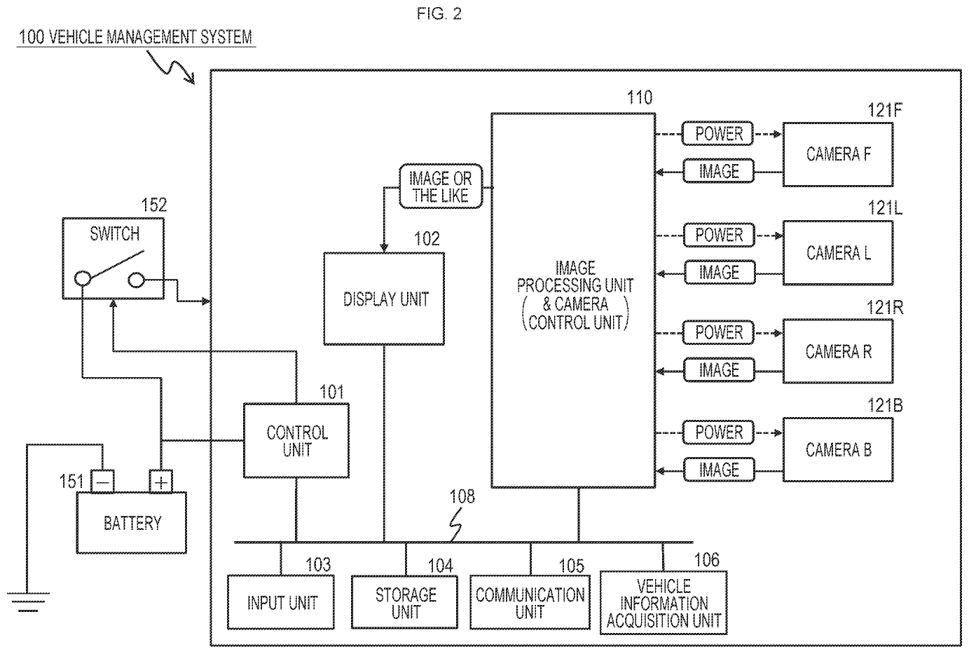

First, a configuration example of a vehicle management system 100 according to the present disclosure will be described with reference to FIG. 2.

As with the vehicle 10 described with reference to FIG. 1, the vehicle management system 100 shown in FIG. 2 includes four cameras that capture images of a front view, a rear view, a left-side view, and a right-side view from a vehicle, that is, a surround-view camera system.

A configuration of the vehicle management system 100 according to the present disclosure will be described with reference to FIG. 2.

The vehicle management system 100 shown in FIG. 2 is an apparatus to be provided in a vehicle. Power is supplied from a battery 151 via a switch 152. Specifically, the switch 152 is, for example, an ignition key switch that can be operated by the driver. Note that some component units of the vehicle management system 100, such as a control unit 101, a communication unit 105, and a theft monitoring system (not shown), are constantly supplied with minimum power required for processing even when the switch 152 is off.

As shown in the drawing, the vehicle management system 100 includes the control unit 101, a display unit 102, an input unit 103, a storage unit 104, the communication unit 105, a vehicle information acquisition unit 106, and an image processing unit 110. Moreover, the vehicle management system 100 includes four cameras 121 provided on the front, back, left, and right of the vehicle.

Note that the elements such as the display unit 102, the image processing unit 110, and the four cameras 121 can also be configured as separate devices including their own respective casings independent of each other.

As with the vehicle 10 described with reference to FIG. 1, the four cameras 121 are four cameras that capture images of a front view, a rear view, a left-side view, and a right-side view from the vehicle, and are cameras for generating a surround-view image. A camera F 121F shown in FIG. 2 is a camera that captures an image of a front view from the vehicle. A camera L 121L is a camera that captures an image of a left-side view from the vehicle. A camera R 121R is a camera that captures an image of a right-side view from the vehicle. A camera B 121B is a camera that captures an image of a rear view from the vehicle.

Each of these cameras includes a wide-angle lens such as a fisheye lens, and can capture an image of a wider area, that is, capture an image with a wider angle of view.

The image processing unit 110 inputs the images captured by these four cameras, and generates a surround-view image described above with reference to FIG. 1, that is, an image of the vehicle and surroundings thereof observed from above. Then, the image processing unit 110 displays the generated image on the display unit 102. The display unit 102 is a display unit including a display such as a liquid crystal display device located in such a way as to enable the driver in the driver's seat to observe images on the display.

The image processing unit 110 not only performs a process of inputting the images captured by the four cameras and generating a surround-view image, but also performs control of the four cameras. As the control of the four cameras, the image processing unit 110 performs, for example, control of power supply to the four cameras and control of the startup of the four cameras in addition to control of the start and stop of capturing images and control of settings for capturing images such as the angle of view and zooms.

Moreover, the image processing unit 110 inputs the images captured by the four cameras, and also performs processes of analysis of the captured images such as analysis of surrounding conditions of the vehicle based on the captured images and analysis of character/numerical information on the surroundings of the vehicle, such as a parking position identification number, based on the captured images.

Moreover, for example, the image processing unit 110 controls a process of storing the images captured by the four cameras in the storage unit 104, and performs a process of selecting or generating a transmission image to be transmitted to an external device such as a server or a user terminal.

Details of these processes will be described later.

The input unit 103 includes, for example, a switch and operation parts that can be operated by the user. Note that, for example, a touch panel of a user interface (UI) screen displayed on the display unit 102 also functions as the input unit 103.

The storage unit 104 is a data storage means including various constituent elements, such as a removable medium, a RAM, and a ROM, in addition to a large-capacity storage device such as a hard disk.

The communication unit 105 communicates with an external device such as a server or a user terminal such as a user's smartphone by applying at least one of various communication means such as Wi-Fi, 4G, LTE, or Bluetooth (registered trademark).

The vehicle information acquisition unit 106 acquires operation information on the operation parts, such as a steering wheel, an accelerator, and a brake, to be operated by the driver when the vehicle is moving. Moreover, the vehicle information acquisition unit 106 may be configured to acquire detection information on detection by a sensor or the like.

The control unit 101 controls various processes to be performed in the vehicle management system 100. Note that the control unit 101 includes a data processing unit having a program execution function, such as a CPU, and controls the various processes to be performed in the vehicle management system 100 according to a program stored in the storage unit 104, for example.

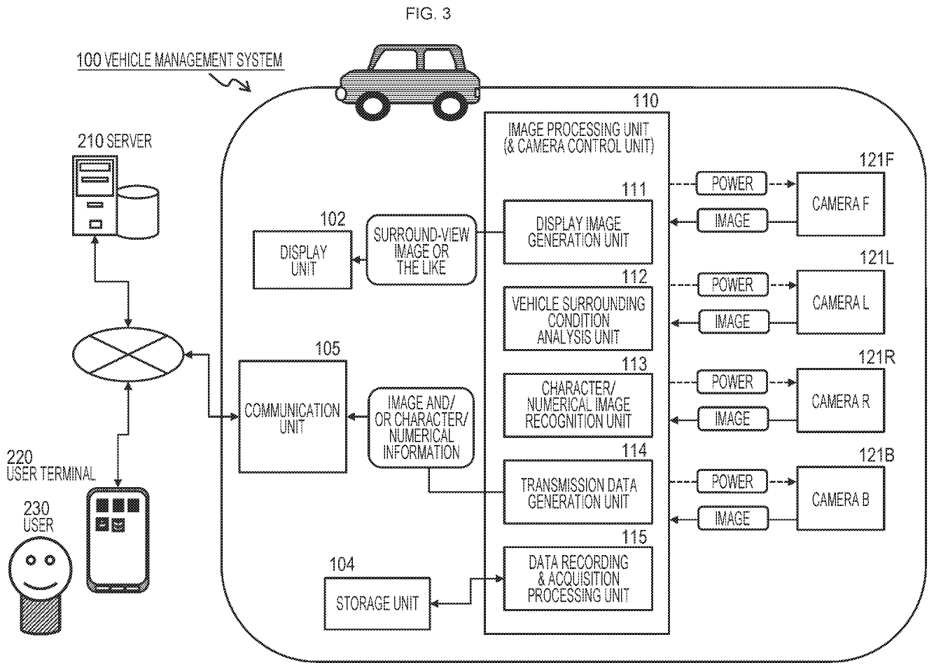

Next, a configuration for communication between the vehicle management system 100 shown in FIG. 2 and an external server or user terminal will be described with reference to FIG. 3.

FIG. 3 shows a partial configuration of the vehicle management system 100 described with reference to FIG. 2, and a server 210 and a user terminal 220 that perform communication with the vehicle management system 100.

The vehicle management system 100, the server 210, and the user terminal 220 are configured to be capable of communicating with each other.

Note that, for example, Wi-Fi, 4G, LTE, and Bluetooth (registered trademark) are used as the communication means, as described above.

The user terminal 220 is, for example, a mobile terminal such as a smartphone held by a user 230 who is a driver. Note that the user terminal 220 is not limited to a smartphone, but may be a mobile PC, a tablet terminal, or the like. In any case, the user terminal 220 is a terminal including a display unit capable of displaying an image.

The vehicle management system 100 communicates with the server 210 or the user terminal 220 via the communication unit 105.

For example, the vehicle management system 100 transmits images captured by the cameras 121 of the vehicle to the user terminal 220 or the server 210.

The transmission images are, for example, either of the following images.

(1) Past images captured by the cameras 121 at the time of parking the vehicle and stored in the storage unit

(2) Current images captured by the cameras 121 in response to an image transmission request from the user terminal 220

The process of transmitting the images captured at the time of parking as set forth in (1) above is an image transmission process in which the vehicle management system 100 plays a leading role, that is, a push-type process.

Meanwhile, the process of transmitting the current images captured in response to a request from the user terminal 220 as set forth in (2) above is an image transmission process to be performed in response to an image request transmission from the user terminal 220 side, that is, a fetch-type process.

The sequence and specific examples of these image transmission processes will be described in detail later.

As a result of image transmission described above, the user 230 who is away from the parked vehicle can display and check the images captured when the vehicle was parked or the current images captured at the parking position, on the user terminal 220. Note that the following two transmission paths are available for transmission of an image: a transmission path to be used in a case where the image is directly transmitted from the vehicle management system 100 to the user terminal 220, and a transmission path to be used in a case where the image is uploaded from the vehicle management system 100 to the server 210 and stored in a storage unit of the server 210.

In a case where an image is uploaded from the vehicle management system 100 to the server 210 and stored in the storage unit of the server 210, the user 230 accesses the server 210 by using the user terminal 220, to view the image held by the server 210 or to download and display the image on the display unit of the user terminal 220. As a result of this process, the user 230 can check the images captured when the vehicle was parked or the current images captured at the parking position.

As described above, FIG. 3 shows a partial configuration of the vehicle management system 100 described with reference to FIG. 2. In addition, FIG. 3 shows a configuration of the image processing unit 110 in units of execution functions as separate blocks.

As shown in FIG. 3, the image processing unit 110 includes a display image generation unit 111, a vehicle surrounding condition analysis unit 112, a character/numerical image recognition unit 113, a transmission data generation unit 114, and a data recording & acquisition processing unit 115.

The display image generation unit 111 inputs the images captured by the four cameras 121F to 121B, generates the surround-view image described above with reference to FIG. 1, that is, the image of the vehicle and the surroundings thereof observed from above, and displays the generated image on the display unit 102 located in such a way as to enable the driver in the driver's seat to observe images on the display unit 102. Note that the images captured by the four cameras 121F to 121B are moving images, and the surround-view image generated by the display image generation unit 111 and displayed on the display unit 102 is also a moving image.

Note that the display image generation unit 111 not only generates a surround-view image from the images captured by the four cameras 121F to 121B, but also performs a display image generation process for switching between the respective images captured by the four cameras 121F to 121B and separately display the images on the display unit 102.

Note that it is possible to switch display images on the display unit 102 according to an instruction from the user (driver).

Note that the four cameras 121F to 121B are images captured by wide-angle lenses and even if the images are viewed as they are, the images are different from images actually seen with the naked eye. Therefore, the display image generation unit 111 performs an image conversion process for converting these captured images into images equivalent to those captured by normal cameras, and outputs the converted images to the display unit 102.

As a result of the image switching performed by the user (driver), any image of the front view, the rear view, the left-side view, or the right-side view from the vehicle is displayed on the display unit 102.

The vehicle surrounding condition analysis unit 112 inputs the images captured by the four cameras 121F to 121B, and analyzes the surrounding conditions of the vehicle on the basis of the captured images. For example, in a case where, for example, detection of an obstacle is performed and a situation is detected in which the vehicle is approaching an obstacle, the vehicle surrounding condition analysis unit 112 provides notification of detection information to the control unit 101, and outputs a warning (alarm) through the display unit 102, a speaker (not shown), or the like under the control of the control unit 101.

The character/numerical image recognition unit 113 inputs the images captured by the four cameras 121F to 121B, and searches for character/numerical information included in the captured images. In a case where an image area including the character/numerical information is detected, the character/numerical image recognition unit 113 converts the detected character/numerical information into text data, and outputs detection information (text information, image frame information, and image area information) to the transmission data generation unit 114 and the data recording & acquisition processing unit 115.

The character/numerical information refers to, for example, parking position identification numbers corresponding to parking positions, and numbers, characters, and the like recorded on pillars, poles, walls, and the like of parking lots.

The transmission data generation unit 114 generates or acquires data to be transmitted to the server 210 or the user terminal 220 via the communication unit 105.

As described above, the transmission images to be transmitted to the server 210 or the user terminal 220 are, for example, either of the following images.

(1) Past images captured by the cameras 121 at the time of parking the vehicle and stored in the storage unit

(2) Current images captured by the cameras 121 in response to an image transmission request from the user terminal 220

In a case where the past images captured as set forth in (1) above are transmitted, the transmission data generation unit 114 acquires the captured images stored in the storage unit 104 via the data recording & acquisition processing unit 115, and uses the acquired images as transmission data.

Furthermore, in a case where the current images captured as set forth in (2) above are transmitted, the surround-view image generated by the display image generation unit 111 on the basis of the images captured by the four cameras 121F to 121B, or the converted images of the respective images captured by the four cameras 121F to 121B are input and used as transmission data.

In addition, the transmission data generation unit 114 may use the respective images captured by the four cameras 121F to 121B to generate a 360-degree panoramic moving image in which horizontal-direction images of the surroundings of the vehicle are sequentially displayed, and use the moving image as transmission data.

Moreover, the transmission data generation unit 114 performs not only the process of transmitting these pieces of image data, but also a process in which, for example, text data of the character/numerical information detected in the numerical image recognition unit 113 from the images captured by the cameras are input and used as transmission data.

As described above, the character/numerical information refers to, for example, parking position identification numbers corresponding to parking positions, and numbers, characters, and the like recorded on pillars, poles, walls, and the like of parking lots, and these pieces of information are provided to the user 230.

The user 230 can check the parking position from the image of the surroundings of the vehicle, and can also check the parking position from information such as the parking position number.

The data recording & acquisition processing unit 115 inputs the surround-view image generated by the display image generation unit 111 on the basis of the images captured by the four cameras 121F to 121B, or the converted images of the respective images captured by the four cameras 121F to 121B, and stores these images in the storage unit 104.

Note that in a case where the image data are stored in the storage unit 104, it is desirable to store the image data after performing compression processing on the image to reduce a data amount.

Moreover, the data recording & acquisition processing unit 115 inputs the text data of the character/numerical information detected in the numerical image recognition unit 113 from the images captured by the cameras, and also stores the text data in the storage unit 104.

In addition, the data recording & acquisition processing unit 115 acquires, from the storage unit 104, data for transmission in response to a request from the transmission data generation unit 114.

Note that the data recording & acquisition processing unit 115 performs a process of storing data obtained within a certain period of time, such as the latest data obtained in about one minute, by replacing old data stored in the storage unit 104 with the data obtained within the certain period of time. That is, the storage unit 104 is set in a state in which the latest data corresponding to a predetermined period of time (for example, one minute) are constantly stored in the storage unit 104.

For example, when a parking process is performed in which the vehicle is stopped and the driver stops an engine, an image capturing process is stopped and update of data stored in the storage unit 104 is also stopped.

As a result, the storage unit 104 is set in a state in which data corresponding to the predetermined period of time before completion of the parking process are stored in the storage unit 104.

In a case where the push process described above, that is, the process of transmitting the images captured at the time of parking to the server 210 or the user terminal 220 is performed, the transmission data generation unit 114 performs a process of acquiring and transmitting the images stored in the storage unit 104, that is, the data corresponding to the predetermined period of time before the time of parking.

### 3. Regarding Specific Examples of Process of Data Transmission from Vehicle Management System

Next, a description will be given of specific examples of the process of data transmission from the vehicle management system.

As described above, the vehicle management system 100 transmits, for example, the images captured by the cameras 121 of the vehicle or data generated on the basis of the images to the user terminal 220 or the server 210.

As described above, the transmission images are, for example, either of the following images.

(1) Past images captured by the cameras 121 at the time of parking the vehicle and stored in the storage unit

(2) Current images captured by the cameras 121 in response to an image transmission request from the user terminal 220

The process of transmitting the images captured at the time of parking as set forth in (1) above is an image transmission process in which the vehicle management system 100 plays a leading role, that is, a push-type process.

Meanwhile, the process of transmitting the current images captured in response to a request from the user terminal 220 as set forth in (2) above is an image transmission process to be performed in response to an image request transmission from the user terminal 220 side, that is, a fetch-type process.

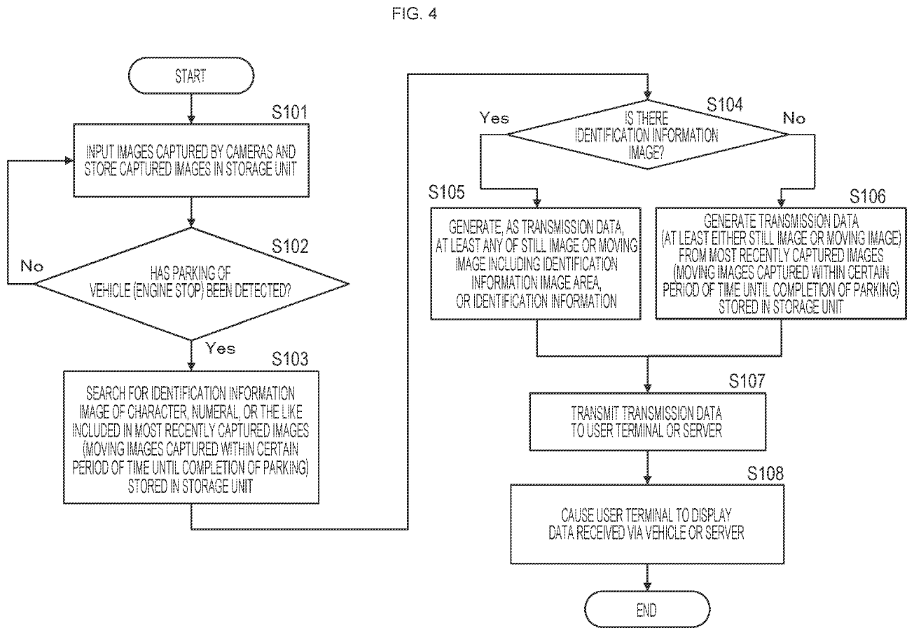

Specific examples of respective process sequences and transmission data for the push-type process and the fetch-type process will be sequentially described with reference to FIG. 4 and subsequent drawings.

### 3-1. Regarding Process of Data Transmission from Vehicle Management System to be Performed as Push-Type Process

First, a process of data transmission from the vehicle management system to be performed as a push-type process will be described.

The process sequence of the process of data transmission from the vehicle management system to be performed as a push-type process will be described with reference to a flowchart shown in FIG. 4.

Note that the process according to the flowchart shown in FIG. 4 can be performed in accordance with the program stored in the storage unit of the vehicle management system 100 under the control of, for example, the control unit (data processing unit) 101 including a processor such as a CPU having a program execution function.

Processing in each step shown in the flowchart of FIG. 4 will be described below.

(Step S101)

First, in step S101, the image processing unit 110 of the vehicle management system 100 inputs the images captured by the four cameras 121F to 121B, and stores the images in the storage unit 104.

This process is a process to be performed by the data recording & acquisition processing unit 115. The data recording & acquisition processing unit 115 inputs the surround-view image generated by the display image generation unit 111 on the basis of the images captured by the four cameras 121F to 121B, or the converted images of the respective images captured by the four cameras 121F to 121B, and stores these images in the storage unit 104.

As described above, the data recording & acquisition processing unit 115 performs a recorded data update process in which old data stored in the storage unit 104 are sequentially replaced with the latest data and the latest data are recorded in the storage unit 104. As a result of this process, the latest data corresponding to the predetermined period of time (for example, one minute) are constantly stored in the storage unit 104.

Note that the respective images captured by the four cameras 121F to 121B may be stored in the storage unit 104 as they are, instead of the surround-view image or the converted images of the respective images captured by the four cameras 121F to 121B.

In this case, the display image generation unit 111 reads the images from the storage unit 104, performs image processing on the read images to generate a surround-view image or converted images of the respective images captured by the four cameras 121F to 121B, and use the generated images as display images or transmission data.

(Step S102)

Next, in step S102, the control unit 101 detects whether or not the vehicle has been parked, that is, the engine has been stopped.

This is detected on the basis of the stop of power supply from the switch 152 shown in FIG. 2, such as an ignition key switch that can be operated by the driver.

Note that as power supply via the switch 152 is stopped, power supply to the four cameras 121F to 121B is also stopped, so that the image capturing process is stopped.

In a case where completion of the parking of the vehicle (engine stop) is not detected in step S102, the process returns to step S101 to continue the process of capturing images with the cameras and recording the captured images.

Meanwhile, in a case where completion of the parking of the vehicle (engine stop) is detected in step S102, the process proceeds to step S103.

(Step S103)

In a case where completion of the parking of the vehicle (engine stop) is detected in step S102, the process proceeds to step S103, in which a search is made for identification information such as a character, a numeral, or a symbol included in most recently captured images (moving images captured within a certain period of time before completion of the parking) stored in the storage unit 104.

This process is a process to be performed by the character/numerical image recognition unit 113 of the image processing unit 110.

The character/numerical image recognition unit 113 inputs images representing a state immediately before the parking and stored in the storage unit 104, and searches for identification information such as character/numerical information included in the image. The identification information refers to, for example, parking position identification numbers corresponding to parking positions, and numbers, characters, and the like recorded on pillars, poles, walls, and the like of parking lots.

(Step S104)

Step S104 is branch processing based on a result of the identification information search process in step S103.

In a case where identification information such as character/numerical information is detected as a result of the identification information search process in step S103, the process proceeds to step S105.

Meanwhile, in a case where identification information such as character/numerical information is not detected, the process proceeds to step S106.

(Step S105)

Processing in step S105 is processing to be performed by the transmission data generation unit 114 in a case where identification information such as character/numerical information is detected as a result of the identification information search process in step S103.

In step S105, the transmission data generation unit 114 generates transmission data including at least any of still image or moving image data including an image area of the identification information or text data of the identification information.

(Step S106)

Processing in step S106 is processing to be performed by the transmission data generation unit 114 in a case where identification information such as character/numerical information is not detected as a result of the identification information search process in step S103.

In step S106, the transmission data generation unit 114 generates transmission data on the basis of images stored in the storage unit 104, that is, the moving images representing the state immediately before the parking process. The transmission data include, for example, either a still image or a moving image, or both.

The transmission data include, for example, a surround-view image generated as a result of image processing performed by the display image generation unit 111 or the respective images captured by the four cameras 121F to 121B.

In addition, the transmission data generation unit 114 may use the respective images captured by the four cameras 121F to 121B to generate a 360-degree panoramic moving image in which horizontal-direction images of the surroundings of the vehicle are sequentially displayed, and use the moving image as transmission data.

(Step S107)

Next, the transmission data generation unit 114 transmits the transmission data generated in step S105 or step S106 to the user terminal 220 or the server 210 via the communication unit 105 in step S107.

(Step S108)

Processing in step S108, which is the last step, is processing to be performed by the user terminal 220.

In step S108, the user terminal displays the data transmitted by the vehicle management system 100 on the display unit of the user terminal 220.

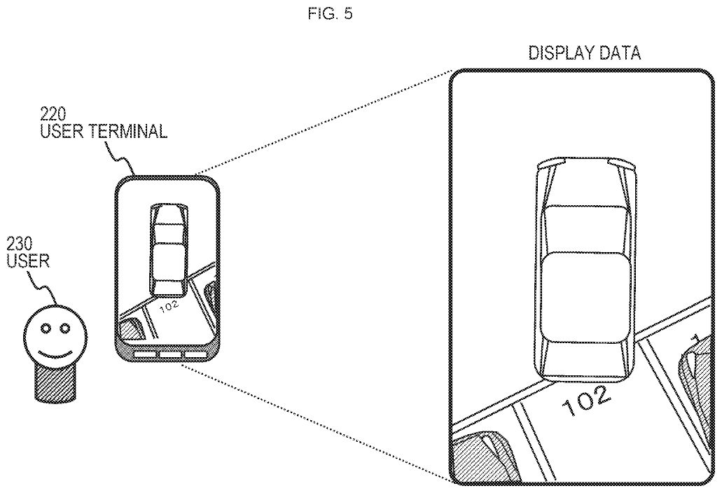

FIG. 5 shows a specific example of the data displayed on the display unit of the user terminal 220.

FIG. 5 shows an example of displaying the transmission data generated in step S105.

In step S105, transmission data are generated which include at least any of still image or moving image data including an image area of the identification information or text data of the identification information.

FIG. 5 shows display data as an example of image display of a constituent frame in a still image or a moving image including a parking position number detected from the moving image (surround-view image) representing the state immediately before the parking.

The user 230 can check the parking position of the vehicle by viewing this image.

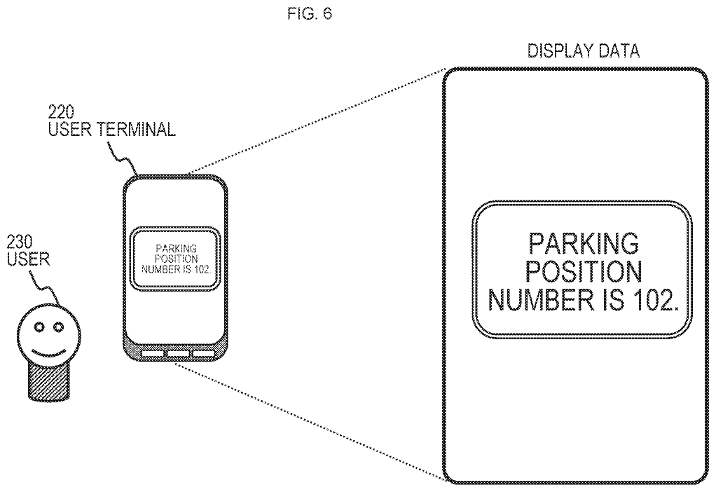

FIG. 6 shows another specific example of data to be displayed on the display unit of the user terminal 220.

FIG. 6 also shows an example of displaying the transmission data generated in step S105.

As described above, in step S105, transmission data are generated which include at least any of still image or moving image data including an image area of the identification information or text data of the identification information.

FIG. 6 shows display data as an example of displaying text data (102) generated on the basis of the parking position number detected from the moving image (surround-view image) representing the state immediately before the parking.

Note that the phrase including the parking position number (preceding and following parking position numbers are . . . ) corresponds to text data displayed by an application that executes this process.

The user 230 can check the parking position of the vehicle by viewing this text image.

Note that the transmission data display examples shown in FIGS. 5 and 6 are merely examples of a part of transmission data, and instead thereof, for example, all the moving images stored in the storage unit 104, that is, the moving images captured within the certain period of time before completion of the parking process may be transmitted and displayed. The moving image may be a surround-view image or an image captured individually by each camera.

The image captured individually by each camera may be an image converted into an image equivalent to that captured by a normal camera. Alternatively, an image captured in a wide-angle shot may be used as it is.

Furthermore, as described above, it is also possible to use the 360-degree panoramic moving image, in which horizontal-direction images of the surroundings of the vehicle are sequentially displayed, generated by use of the respective images captured by the four cameras 121F to 121B.

Moreover, for example, the display image may be zoomed or the point of view may be changed in accordance with operation performed on the user terminal 220 to display an image desired by the user. These processes can be implemented by the function of an application that outputs images.

The user 230 can check a situation around the parking position again from these images. Thus, even in a case where the parking number as a parking position identifier cannot be checked, the user 230 can easily determine the parking position by performing a process of, for example, comparison between the images and surrounding scenery.

### 3-2. Regarding Process of Data Transmission from Vehicle Management System to Be Performed as Fetch-type Process

Next, a process of data transmission from the vehicle management system to be performed as a fetch-type process will be described.

The fetch-type process is a process in which the vehicle management system 100 transmits the current images captured by the cameras 121, in response to the image transmission request from the user terminal 220.

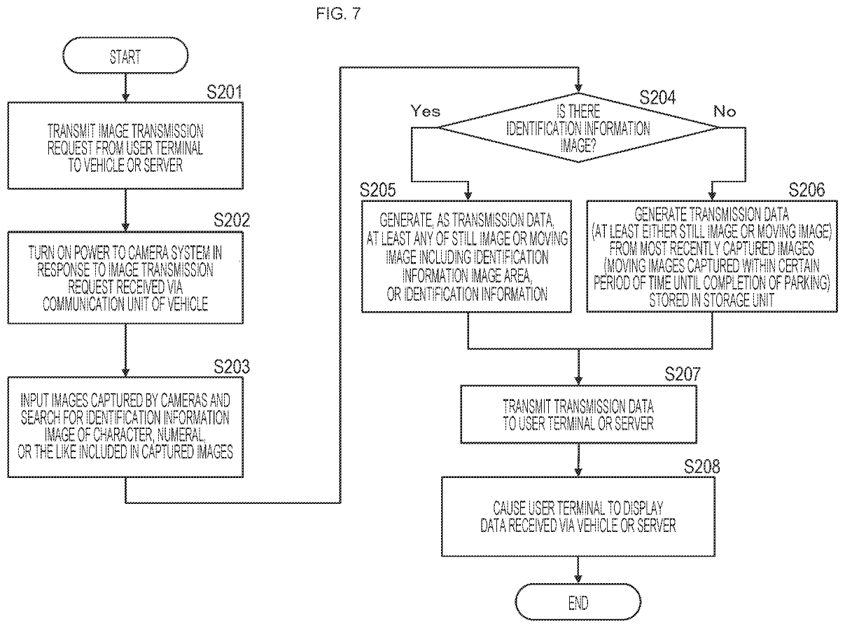

The process sequence of the process of data transmission from the vehicle management system to be performed as a fetch-type process will be described with reference to a flowchart shown in FIG. 7.

Note that the process according to the flowchart shown in FIG. 7 can be performed in accordance with the program stored in the storage unit of the vehicle management system 100 under the control of, for example, the control unit (data processing unit) 101 including the processor such as a CPU having a program execution function.

Processing in each step shown in the flowchart of FIG. 7 will be described below.

(Step S201)

Processing in step S201 is processing to be performed in the user terminal 220.

In step S201, the user terminal 220 transmits an image transmission request to the vehicle management system 100 of the vehicle or the server 210.

In a case where the image transmission request is transmitted to the server 210, the server 210 transfers the image transmission request to the vehicle management system 100.

Note that an ID of the user terminal 220 or an ID of the vehicle management system 100 is added to the image transmission request from the user terminal 220.

The server 210 holds data on the correspondence between IDs of the user terminals 220 and IDs of the vehicle management systems 100 in a database. On the basis of the data, the server 210 determines a vehicle management system to which the image transmission request from the user terminal 220 is to be transferred, and transfers the image transmission request from the user terminal 220 to the determined vehicle management system 100.

(Step S202)

Processing in step S202 is processing to be performed by the vehicle management system 100.

When the vehicle management system 100 receives, via the communication unit 105, the image transmission request from the user terminal 220 or the image transmission request transferred from the server 210, the control unit 101 sets the switch 152 to ON to start supplying power to the image processing unit 110 and the camera system including the four cameras 121F to B.

(Step S203)

Next, in step S203, the image processing unit 110 of the vehicle management system 100 inputs the images captured by the four cameras 121F to 121B, and searches the input images for identification information such as a character, a numeral, or a symbol.

This process is a process to be performed by the character/numerical image recognition unit 113 of the image processing unit 110.

The character/numerical image recognition unit 113 inputs images representing a state immediately before the parking and stored in the storage unit 104, and searches for identification information such as character/numerical information included in the image. The identification information refers to, for example, parking position identification numbers corresponding to parking positions, and numbers, characters, and the like recorded on pillars, poles, walls, and the like of parking lots.

(Steps S204 to S208)

Processing steps of steps S204 to S208 are similar to those of steps S104 to S108 of the flow described above with reference to FIG. 4.

First, step S204 is branch processing based on the result of the identification information search process in step S203. In a case where identification information such as character/numerical information is detected as a result of the identification information search process in step S203, the process proceeds to step S205.

Meanwhile, in a case where identification information such as character/numerical information is not detected, the process proceeds to step S206.

Processing in step S205 is processing to be performed by the transmission data generation unit 114 in a case where identification information such as character/numerical information is detected as a result of the identification information search process in step S203.

In step S205, the transmission data generation unit 114 generates transmission data including at least any of still image or moving image data including an image area of the identification information or text data of the identification information.

Processing in step S206 is processing to be performed by the transmission data generation unit 114 in a case where identification information such as character/numerical information is not detected as a result of the identification information search process in step S203.

In step S206, the transmission data generation unit 114 generates transmission data on the basis of the images captured by the cameras. The transmission data include, for example, either a still image or a moving image, or both.

The transmission data include, for example, a surround-view image generated as a result of image processing performed by the display image generation unit 111 or the respective images captured by the four cameras 121F to 121B. In addition, the transmission data generation unit 114 may use the respective images captured by the four cameras 121F to 121B to generate a 360-degree panoramic moving image in which horizontal-direction images of the surroundings of the vehicle are sequentially displayed, and use the moving image as transmission data.

Next, the transmission data generation unit 114 transmits the transmission data generated in step S205 or step S206 to the user terminal 220 or the server 210 via the communication unit 105 in step S207.

Processing in step S208, which is the last step, is processing to be performed by the user terminal 220.

In step S208, the user terminal displays the data transmitted by the vehicle management system 100 on the display unit of the user terminal 220.

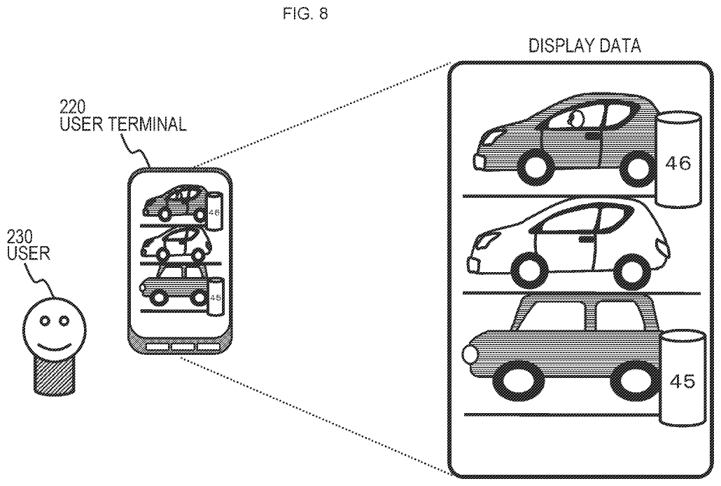

FIG. 8 shows a specific example of the data displayed on the display unit of the user terminal 220.

FIG. 8 shows an example of displaying the transmission data generated in step S205.

In step S205, transmission data are generated which include at least any of still image or moving image data including an image area of the identification information or text data of the identification information.

The display data shown in FIG. 8 correspond to an image of a right-side view captured by the camera 121R provided on the right side surface of the parked vehicle.

The user 230 can check the parking position of the vehicle by, for example, comparing this image with surrounding scenery.

Note that the transmission data display example shown in FIG. 8 is merely an example, and instead thereof, for example, all real-time moving images captured by the cameras 121 may be transmitted and displayed. The moving image may be a surround-view image or an image captured individually by each camera. Furthermore, as described above, it is also possible to use the 360-degree panoramic moving image, in which horizontal-direction images of the surroundings of the vehicle are sequentially displayed, generated by use of the respective images captured by the four cameras 121F to 121B.

The user 230 can check a current situation around the parking position again from these images. Thus, even in a case where the parking number as a parking position identifier cannot be checked, the user 230 can easily determine the parking position by performing a process of, for example, comparison between the images and surrounding scenery.

### 4. Regarding Hardware Configuration Example of Vehicle Management System, User Terminal, and Server

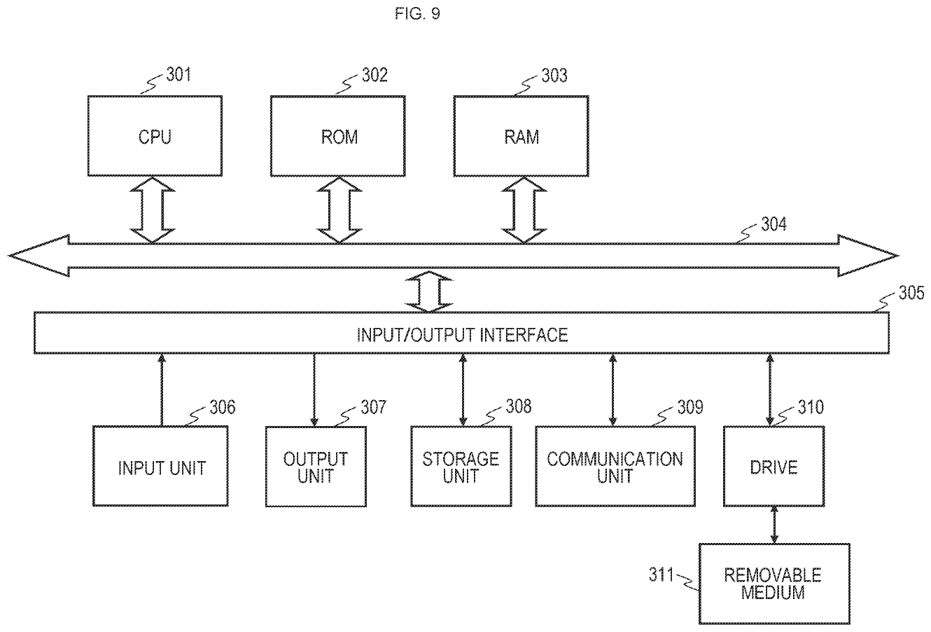

Next, a hardware configuration example of the vehicle management system 100, the user terminal 220, and the server 210 that perform the above-described processing will be described with reference to FIG. 9.

FIG. 9 is a diagram showing a configuration example of hardware that can be applied as the vehicle management system 100, the user terminal 220, and the server 210.

The configuration shown in FIG. 9 will be described. A central processing unit (CPU) 301 functions as a data processing unit that performs various types of processing according to programs stored in a read only memory (ROM) 302 or a storage unit 308. For example, the CPU 301 performs processing according to the sequence described in the embodiment above. Programs to be executed by the CPU 301, data, and the like are stored in a random access memory (RAM) 303. The CPU 301, the ROM 302, and the RAM 303 are connected to each other by a bus 304.

The CPU 301 is connected to an input/output interface 305 via the bus 304. The input/output interface 305 is connected to an input unit 306 and an output unit 307. The input unit 306 includes, for example, various switches, a keyboard, a touch panel, a mouse, and a microphone, and also includes a situation data acquisition unit including a sensor, a camera, a GPS, and the like. The output unit 307 includes a display, a speaker, and the like.

The CPU 301 receives commands, situation data, and the like input from the input unit 306, performs various types of processing, and outputs processing results to, for example, the output unit 307.

The storage unit 308 connected to the input/output interface 305 includes, for example, a hard disk, and stores the programs to be executed by the CPU 301 and various data. A communication unit 309 functions as a transmission/reception unit for data communication via a network such as the Internet or a local area network, and communicates with an external device.

A drive 310 connected to the input/output interface 305 drives a removable medium 311 to perform the recording or reading of data. Examples of the removable medium 311 include a magnetic disk, an optical disk, a magneto-optical disk, and a semiconductor memory such as a memory card.

### 5. Summary of Configuration of Present Disclosure

The embodiment of the present disclosure has been described above in detail with reference to specific examples. However, it is obvious that those skilled in the art can make modifications and substitutions of the embodiment without departing from the gist of the present disclosure. In other words, the present invention has been disclosed in the form of exemplification, and should not be restrictively interpreted. In order to judge the gist of the present disclosure, the section “CLAIMS” should be taken into consideration.

Note that the technology disclosed in the present specification can adopt the following configurations.

(1) An information processing apparatus including:

an image processing unit that inputs an image captured by a camera, and generates transmission data to be transmitted to an external device, the camera being configured to capture an image of surroundings of a vehicle,

in which the image processing unit stores a moving image captured at a time of parking the vehicle in a storage unit, generates transmission data by using the moving image captured at the time of parking the vehicle and stored in the storage unit, and transmits the generated transmission data to the external device via a communication unit.

(2) The information processing apparatus according to (1), in which

the vehicle is equipped with a plurality of the cameras located on front, back, left, and right of the vehicle, and

the image processing unit generates a surround-view image corresponding to an observation image of the vehicle viewed from above on the basis of images captured by the plurality of cameras, and transmits the generated surround-view image to the external device.

(3) The information processing apparatus according to (1) or (2), in which

the image processing unit detects identification information including a character, a numeral, or a symbol from the image captured by the camera, selects an image including the detected identification information, as transmission data, and transmits the selected image to the external device.

(4) The information processing apparatus according to (3), in which

the image processing unit converts the identification information into text data, and transmits the text data as transmission data to the external device.

(5) The information processing apparatus according to any one of (1) to (4), in which

the image processing unit stores the image captured by the camera in the storage unit, and sequentially performs a process of updating data stored in the storage unit such that a latest image captured within a certain period of time is stored in the storage unit.

(6) The information processing apparatus according to any one of (1) to (5), in which

the image processing unit stops a process of causing the camera to capture an image and a process of storing the captured image in the storage unit, in response to an engine stop process after the parking of the vehicle, and transmits a moving image as transmission data to the external device after a parking process, the moving image being captured during the parking process and stored in the storage unit.

(7) The information processing apparatus according to any one of (1) to (6), in which

the external device is a user terminal or a server.

(8) The information processing apparatus according to any one of (1) to (7), further including:

a control unit that controls power supply to the image processing unit and the camera in response to an image transmission request from a user terminal as the external device,

in which in response to the image transmission request from the user terminal, the information processing apparatus generates transmission data by using the image captured by the camera, and transmits the generated transmission data to the user terminal or a server accessible to the user terminal, via the communication unit.

(9) The information processing apparatus according to (8), in which

a real-time image captured by the camera is transmitted as the transmission data.

(10) The information processing apparatus according to (8) or (9), in which

the image processing unit generates a surround-view image as the transmission data.

(11) The information processing apparatus according to any one of (8) to (10), in which

the image processing unit detects identification information including a character, a numeral, or a symbol, and generates an image including the detected identification information, as transmission data.

(12) An information processing system including:

an information processing apparatus installed in a vehicle; and

a user terminal capable of communicating with the information processing apparatus,

in which the information processing apparatus includes an image processing unit that inputs an image captured by a camera, and generates transmission data to be transmitted to the user terminal, the camera being configured to capture an image of surroundings of the vehicle,

the image processing unit stores a moving image captured at a time of parking the vehicle in a storage unit, generates transmission data by using the moving image captured at the time of parking the vehicle and stored in the storage unit, and transmits the generated transmission data to the user terminal via a communication unit, and

the user terminal displays the data received from the information processing apparatus, on a display unit.

(13) The information processing system according to (12), in which

the information processing apparatus transmits the transmission data to a server accessible to the user terminal, and

the user terminal accesses the server to display, on the display unit, the data transmitted from the information processing apparatus to the server.

(14) The information processing system according to (12) or (13), in which

the information processing apparatus detects identification information including a character, a numeral, or a symbol from the image captured by the camera, and transmits, to the user terminal, an image including the detected identification information or text data into which the identification information has been converted, and

the user terminal displays, on the display unit, the image including the identification information or the text data into which the identification information has been converted.

(15) An information processing method to be performed in an information processing apparatus including an image processing unit that inputs an image captured by a camera, and generates transmission data to be transmitted to an external device, the camera being configured to capture an image of surroundings of a vehicle, the method including:

causing the image processing unit to store a moving image captured at a time of parking the vehicle in a storage unit, generate transmission data by using the moving image captured at the time of parking the vehicle and stored in the storage unit, and transmit the generated transmission data to the external device via a communication unit.

(16) An information processing method to be performed in an information processing system, the information processing system including an information processing apparatus installed in a vehicle, and a user terminal capable of communicating with the information processing apparatus, the information processing apparatus including an image processing unit that inputs an image captured by a camera, and generates transmission data to be transmitted to the user terminal, the camera being configured to capture an image of surroundings of the vehicle, the method including:

causing the image processing unit to store a moving image captured at a time of parking the vehicle in a storage unit, generate transmission data by using the moving image captured at the time of parking the vehicle and stored in the storage unit, and transmit the generated transmission data to the user terminal via a communication unit, and

causing the user terminal to display the data received from the information processing apparatus, on a display unit.

(17) A program for causing a vehicle management process to be performed in an information processing apparatus including an image processing unit that inputs an image captured by a camera, and generates transmission data to be transmitted to an external device, the camera being configured to capture an image of surroundings of a vehicle, the program causing the image processing unit to perform:

a process of storing a moving image captured at a time of parking the vehicle in a storage unit;

a process of generating transmission data by using the moving image captured at the time of parking the vehicle and stored in the storage unit; and

a process of transmitting the generated transmission data to the external device via a communication unit.

Furthermore, a series of the processes described in the specification can be implemented by hardware, software, or a configuration in which hardware and software are combined. In a case where the processes are implemented by software, it is possible to execute a program in which a process sequence has been recorded, after installing the program in a memory in a computer incorporated in dedicated hardware or installing the program on a general-purpose computer capable of performing various types of processing. For example, the program can be recorded in advance on a recording medium. In addition to being installed on a computer from the recording medium, the program can be received via a network such as a local area network (LAN) or the Internet and installed on a recording medium such as a built-in hard disk.

Note that the various processes described in the specification may be performed not only in time series according to the description, but also in parallel or separately depending on the processing capacity of an apparatus that performs the processes or depending on the needs. Furthermore, in the present specification, the term “system” refers to a logical set configuration of a plurality of devices, and is not limited to one in which the devices of each configuration are in the same casing, while the devices of each configuration may be in the same casing in some cases.

### INDUSTRIAL APPLICABILITY

As described above, according to the configuration of the one embodiment of the present disclosure, a configuration is implemented in which a user who is away from a vehicle can easily check a vehicle parking position.

Specifically, for example, included is an image processing unit that inputs an image captured by a camera, and generates transmission data to be transmitted to an external device, the camera being configured to capture an image of surroundings of the vehicle. The image processing unit generates transmission data by using a moving image captured at the time of parking the vehicle and stored in a storage unit, and transmits the generated transmission data to an external device such as a user terminal via a communication unit. The image processing unit generates a surround-view image on the basis of images captured by a plurality of cameras provided on the front, back, left, and right of the vehicle, and transmits the generated surround-view image. In addition, the image processing unit detects identification information including a character, a numeral, or a symbol from the image captured by the camera, and transmits an image including the detected identification information.

With the present configuration, a configuration is implemented in which a user who is away from a vehicle can easily check a vehicle parking position.

### REFERENCE SIGNS LIST

10 Vehicle
11 Front camera
12 Rear camera
13 Left side camera
14 Right side camera
100 Vehicle management system
101 Control unit
102 Display unit
103 Input unit
104 Storage unit
105 Communication unit
106 Vehicle information acquisition unit
110 Image processing unit 110
111 Display image generation unit
112 Vehicle surrounding condition analysis unit
113 Character/numerical image recognition unit
114 Transmission data generation unit
115 Data recording & acquisition processing unit
121L to B Camera
151 Battery
152 Switch
301 CPU
302 ROM
303 RAM
304 Bus
305 Input/output interface
306 Input unit
307 Output unit
308 Storage unit
309 Communication unit
310 Drive
311 Removable medium

1. An information processing apparatus comprising:
an image processing unit that inputs an image captured by a camera, and generates transmission data to be transmitted to an external device, the camera being configured to capture an image of surroundings of a vehicle,
wherein the image processing unit stores a moving image captured at a time of parking the vehicle in a storage unit, generates transmission data by using the moving image captured at the time of parking the vehicle and stored in the storage unit, and transmits the generated transmission data to the external device via a communication unit.

2. The information processing apparatus according to claim 1, wherein
the vehicle is equipped with a plurality of the cameras located on front, back, left, and right of the vehicle, and
the image processing unit generates a surround-view image corresponding to an observation image of the vehicle viewed from above on a basis of images captured by the plurality of cameras, and transmits the generated surround-view image to the external device.

3. The information processing apparatus according to claim 1, wherein
the image processing unit detects identification information including a character, a numeral, or a symbol from the image captured by the camera, selects an image including the detected identification information, as transmission data, and transmits the selected image to the external device.

4. The information processing apparatus according to claim 3, wherein
the image processing unit converts the identification information into text data, and transmits the text data as transmission data to the external device.

5. The information processing apparatus according to claim 1, wherein
the image processing unit stores the image captured by the camera in the storage unit, and sequentially performs a process of updating data stored in the storage unit such that a latest image captured within a certain period of time is stored in the storage unit.

6. The information processing apparatus according to claim 1, wherein
the image processing unit stops a process of causing the camera to capture an image and a process of storing the captured image in the storage unit, in response to an engine stop process after the parking of the vehicle, and transmits a moving image as transmission data to the external device after a parking process, the moving image being captured during the parking process and stored in the storage unit.

7. The information processing apparatus according to claim 1, wherein
the external device is a user terminal or a server.

8. The information processing apparatus according to claim 1, further comprising:
a control unit that controls power supply to the image processing unit and the camera in response to an image transmission request from a user terminal as the external device,
wherein in response to the image transmission request from the user terminal, the information processing apparatus generates transmission data by using the image captured by the camera, and transmits the generated transmission data to the user terminal or a server accessible to the user terminal, via the communication unit.

9. The information processing apparatus according to claim 8, wherein
a real-time image captured by the camera is transmitted as the transmission data.

10. The information processing apparatus according to claim 8, wherein
the image processing unit generates a surround-view image as the transmission data.

11. The information processing apparatus according to claim 8, wherein
the image processing unit detects identification information including a character, a numeral, or a symbol, and generates an image including the detected identification information, as transmission data.

12. An information processing system comprising:
an information processing apparatus installed in a vehicle; and
a user terminal capable of communicating with the information processing apparatus,
wherein the information processing apparatus includes an image processing unit that inputs an image captured by a camera, and generates transmission data to be transmitted to the user terminal, the camera being configured to capture an image of surroundings of the vehicle,
the image processing unit stores a moving image captured at a time of parking the vehicle in a storage unit, generates transmission data by using the moving image captured at the time of parking the vehicle and stored in the storage unit, and transmits the generated transmission data to the user terminal via a communication unit, and
the user terminal displays the data received from the information processing apparatus, on a display unit.

13. The information processing system according to claim 12, wherein
the information processing apparatus transmits the transmission data to a server accessible to the user terminal, and
the user terminal accesses the server to display, on the display unit, the data transmitted from the information processing apparatus to the server.

14. The information processing system according to claim 12, wherein
the information processing apparatus detects identification information including a character, a numeral, or a symbol from the image captured by the camera, and transmits, to the user terminal, an image including the detected identification information or text data into which the identification information has been converted, and
the user terminal displays, on the display unit, the image including the identification information or the text data into which the identification information has been converted.

15. An information processing method to be performed in an information processing apparatus including an image processing unit that inputs an image captured by a camera, and generates transmission data to be transmitted to an external device, the camera being configured to capture an image of surroundings of a vehicle, the method comprising:
causing the image processing unit to store a moving image captured at a time of parking the vehicle in a storage unit, generate transmission data by using the moving image captured at the time of parking the vehicle and stored in the storage unit, and transmit the generated transmission data to the external device via a communication unit.

16. An information processing method to be performed in an information processing system, the information processing system including an information processing apparatus installed in a vehicle, and a user terminal capable of communicating with the information processing apparatus, the information processing apparatus including an image processing unit that inputs an image captured by a camera, and generates transmission data to be transmitted to the user terminal, the camera being configured to capture an image of surroundings of the vehicle, the method comprising:
causing the image processing unit to store a moving image captured at a time of parking the vehicle in a storage unit, generate transmission data by using the moving image captured at the time of parking the vehicle and stored in the storage unit, and transmit the generated transmission data to the user terminal via a communication unit, and
causing the user terminal to display the data received from the information processing apparatus, on a display unit.

17. A program for causing a vehicle management process to be performed in an information processing apparatus including an image processing unit that inputs an image captured by a camera, and generates transmission data to be transmitted to an external device, the camera being configured to capture an image of surroundings of a vehicle, the program causing the image processing unit to perform:
a process of storing a moving image captured at a time of parking the vehicle in a storage unit;
a process of generating transmission data by using the moving image captured at the time of parking the vehicle and stored in the storage unit; and
a process of transmitting the generated transmission data to the external device via a communication unit.
